(19) United States
(12) Patent Application Publication
(10) Pub. No.: US 2005/0066190 A1
(43) Pub. Date: Mar. 24, 2005

(54) Electronic archive filter and profiling apparatus, system, method, and electronically stored computer program product

(75) Inventor: John Martin, Round Hill, VA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: CRICKET TECHNOLOGIES LLC, Reston, VA (US)

(21) Appl. No.: 10/749,401

(22) Filed: Jan. 2, 2004

Related U.S. Application Data
(60) Provisional application No. 60/437,440, filed on Jan. 2, 2003.

(51) Int. Cl. G06F 11/30

(52) U.S. Cl. 713/200

(57) ABSTRACT

A software-based electronic data discovery tool which accesses multiple electronic archives; copies files and their meta-data into a common repository; vertically de-duplicates and tags the files; horizontally de-duplicates and tags the files; filters and tags the files against a one or more sets of predetermined compliance and privileged criteria identified by one or more parties associated with a specific electronic data discovery procedure; profiles and tags select results; and produces a variety of reports and excerpts. Production is at least one of printing on paper, transferring to magnetic media, or other processes. Files that are selected for profiling and production are then rendered in TIFF or another related format and stored in a common file. All files are identified with a digital “finger print” and complete chain-of-custody information.

### CROSS-REFERENCE TO RELATED APPLICATIONS

This application is related to co-pending application Ser. No. 10/227,389, filed on Aug. 26, 2002, the entire contents of which are incorporated herein.

### BACKGROUND OF THE INVENTION

1. Field of the Invention

This invention relates to systems, apparatuses, methods, and computer program products relating to electronically stored document data filtering and archiving. More particularly, the invention relates to data that may need to be processed by a party during a discovery phase of litigation.

2. Discussion of the Background

Computer-based discovery in legal proceedings is becoming more and more widespread as tools providing cost effective and legally sound data discovery of electronic information are being developed. An overview of computer-based discovery in federal civil litigation is provided in a Federal Courts Law Review article by Kenneth J. Withers, entitled Computer-Based Discovery in Civil Litigation (October 2000), the entire contents of which are incorporated herein by reference. This article notes how discovery is changing in response to the pervasive use of computers and how more and more cases involve e-mail, word processed documents and spreadsheets, and records of Internet activity. This article discusses some of the potential for computer-based discovery to reduce overall discovery costs and improve the administration of justice. The article also explores the unique problems of computer-based discovery. The appendix provides a checklist of computer based discovery considerations for Rules 16(c) pretrial conferences. Other information related to electronic discovery challenges is found in Practical Guide to Electronic Discovery by Lendino (2001); Same Game, New Rules, E-Discovery Adds Complexity to Protecting Clients and Disadvantaging Opponents by Nimsger (Legal Times, Vol. XXV, No. 10, Mar. 11, 2002); and Put the Byte On, Advancements in Technology Have Complicated the Discovery Process, but Rule 16 Provides Some Guidance by Schultz and Keena (Daily Journal, Sep. 26, 2001); the entire contents of each are hereby incorporated by reference.

In conducting computer-based discovery, problems arise with respect to the vast quantities of electronic documents that must be reviewed, whether for a party's document production in a litigation against another party, for conducting an internal investigation, or for satisfying government reporting requirements. A party's ability to manage each matter that can be mission critical depends on how fast it can capture, identify, review, assess, and produce relevant documents. The volume of electronic documents today far exceeds paper documents.

According to a University of California study, How Much Information by Lyan and Vatian (2000), the entire contents of which are hereby incorporated by reference, over 90% of corporate documents are created electronically and an estimated 70% of those are never printed to paper. Additionally, e-mail communication among employees is approaching three billion a day. This has dramatically increased the volume, complexity, and cost of electronic document discovery. Moreover, emailing-employees (custodians) often have multiple data sets contained in multiple messaging systems. Electronic documents, whether e-mail stored on hard drives, backup tapes, etc. come in numerous file types (e.g., MICROSOFT WORD, NOVEL WORD PERFECT, MICROSOFT EXCEL, LOTUS 123, MICROSOFT OUTLOOK, SYMANTEC ACT, AND MICROSOFT OUTLOOK) as well as numerous versions. These documents are often times encoded as well as may be virus infected. Often a party is required to produce these vast amounts of electronic documents in paper form, a process that can be unjustifiably expensive without telescoping the retrieval of documents based on relevant issues.

FIG. 1 is a flow chart of the conventional electronic document legal discovery process S1000 beginning with sequentially accessing individual electronic archives S101. These individual archives are then rendered, usually in a TIFF format, and stored in a common repository S103. Files from the common repository are then searched and filtered against a predetermined set of keywords S105. Files which are of interest to the legal discovery process are then printed for further evaluation, S107.

Current systems and methods for electronic data discovery are limited in that they convert files to a common format such as TIFF before searching. Conversion to TIFF is slow and expensive. Conversion also results in a master archive that is less amenable to sophisticated searching and de-duplication due to the loss of a great deal of meta-data associated with the files. For example, many file characteristics, file fragments, and file history information are typically lost during the conversion process. Nonetheless, in conventional systems the conversion process is often considered to be a necessary first step to enable economical, brute-force searching and filtering by custodian and/or keyword. What is required, as discovered by the present inventors, is an affordable and efficient method of normalizing disparate data archives and searching these archives prior to conversion to a TIFF or other reproduction format so as to exploit vast amounts of meta-data and fragmentary information natively stored with files.

Also, in the current systems many documents are printed which are eventually found to be redundant, encoded, or somehow corrupted and thus illegible. Furthermore, many search and filtering processes of the current art are rudimentary and result in documents being printed that are not of interest to the legal discovery process. The costs of printing can be exorbitant and costs are greatly increased when review time of legal staff at high hourly rates is added. What is also desired, as recognized by the present inventors, is a way to quickly search and retrieve documents that are relevant to the legal discovery process while not incurring the large expense of having to print largely useless and/or redundant materials that have to be reviewed manually and thereby incurring another expense.

Finally, in current systems expensive, inefficient, and oftentimes redundant systems are required to be used to perform electronic discovery for multiple parties. What is also desired, as recognized by the present inventors, is a way to use a single process and tool set for multiple parties while avoiding data spoliation and/or inappropriate breach of privilege, privacy, or confidentiality.

### SUMMARY OF THE INVENTION

The present invention addresses and resolves the above identified as well as other limitations with conventional electronic file review and legal discovery systems and methods. The present invention provides a low cost, easy-to-implement infrastructure and technology for electronic document discovery. The present invention includes a software-based electronic archive management tool and process that enables users to cost effectively deal with voluminous and complex document discovery.

The software-based electronic data discovery tool of the present invention (a) accesses multiple electronic archives; (b) copies files and their meta-data into a common repository; (c) vertically de-duplicates and tags the files; (d) horizontally de-duplicates and tags the files; (e) filters and tags the files against a one or more sets of predetermined compliance and privileged criteria identified by one or more parties associated with a specific electronic data discovery procedure; (f) profiles and tags select results; and (g) produces a variety of reports and excerpts. Production is at least one of printing on paper, transferring to magnetic media, or other processes. Files that are selected for profiling and production are then rendered in TIFF or another related format and stored in a common file. All files are identified with a digital “finger print” and complete chain-of-custody information.

### BRIEF DESCRIPTION OF THE DRAWINGS

A more complete appreciation of the present invention and many of the attendant advantages thereof will be readily obtained as the same becomes better understood by reference to the following detailed descriptions and accompanying drawings:

FIG. 1 is a flow diagram of a conventional method of litigation support and electronic discovery;

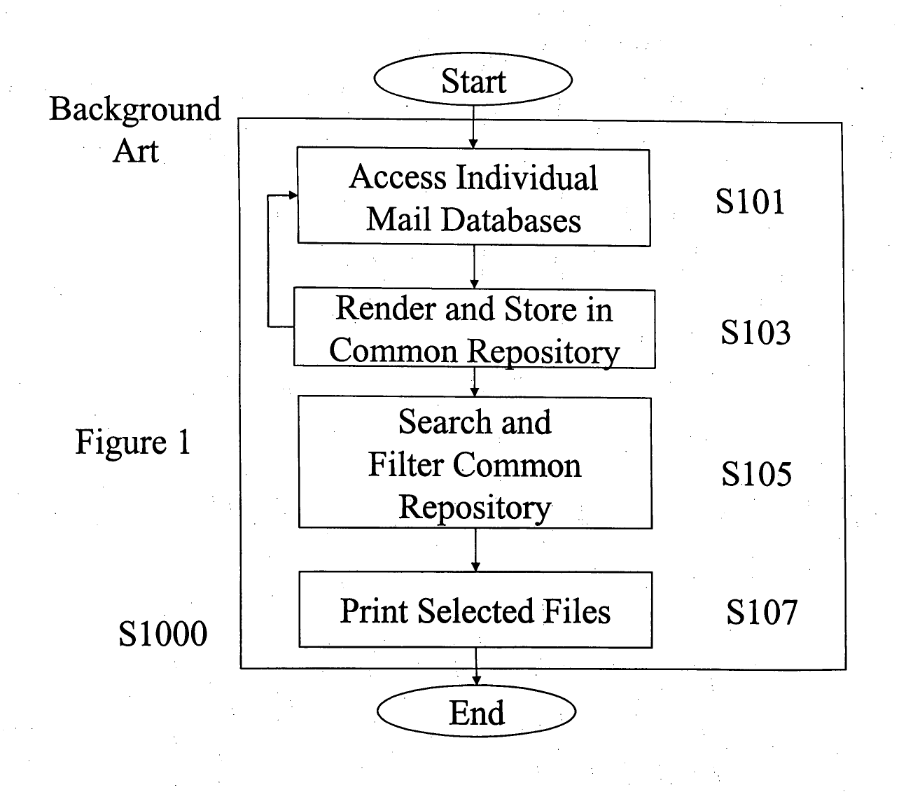

FIG. 2 is a flow diagram of the method of litigation support and electronic discovery of the present invention;

FIG. 3 is a flow diagram of a method of multiple archive mail merging of the present invention;

FIG. 4 is a flow diagram of a method of vertical de-duplication of the present invention;

FIG. 5 is a flow diagram of a method of horizontal de-duplication according to the present invention;

FIG. 6 is a flow diagram of a method of compliance and privilege filtering according to the present invention;

FIG. 7 is a block diagram of the present invention; and

FIG. 8 is a block diagram of a computer associated with the present invention.

### DETAILED DESCRIPTION OF THE PREFERRED EMBODIMENTS

The following comments relate to the drawings, wherein like reference numerals designate identical or corresponding parts throughout the several views.

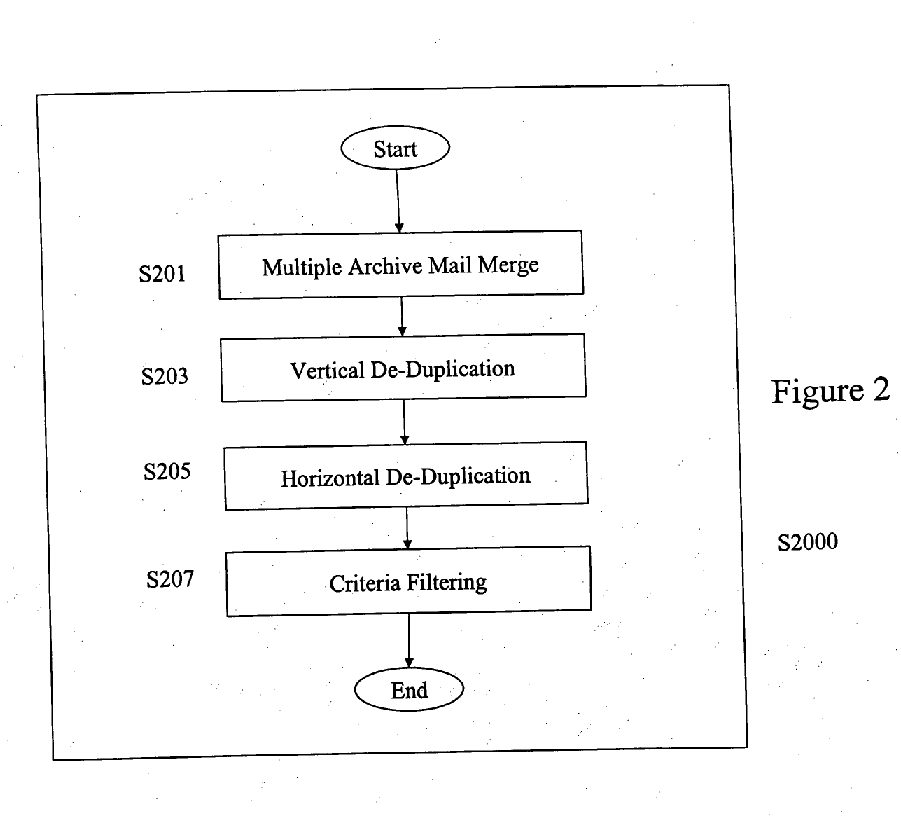

FIG. 2 is a block diagram of the electronic discovery file management process S2000 of the present invention. One or more databases are accessed, tagged, time-stamped, and merged within a single archive S201, the contents of which are searched for duplicates and again tagged and time-stamped S203. Files that have been vertically de-duplicated are then horizontally de-duplicated S205 where files that are duplicated amongst multiple custodians are tagged as duplicates and time-stamped. Once horizontally de-duplicated, files are then filtered against predetermined compliance and privilege criteria, tagged, and time-stamped S207. Files that have been filtered and meet predetermined criteria are then selected for further profiling and production. Files that have been selected for production are tagged, time-stamped, rendered in a format such as TIFF, and stored in the common file.

In alternative embodiments, the order of steps associated with the electronic discovery file management process S2000 may be varied. In other embodiments, one or more steps associated with the electronic discovery file management process S2000 may be excluded.

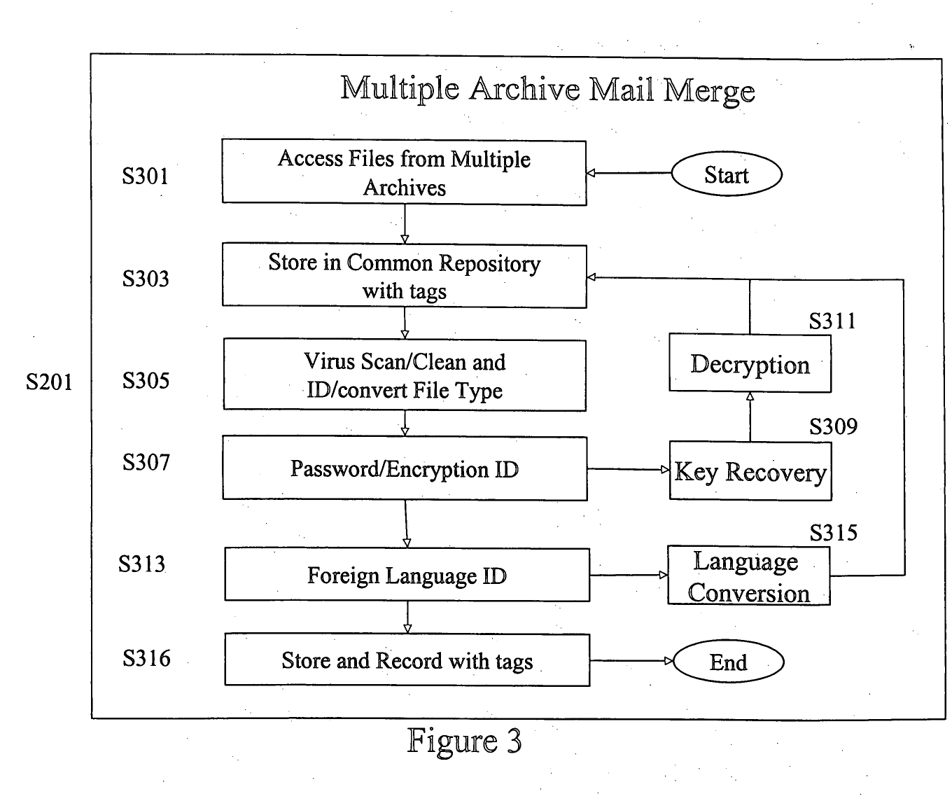

FIG. 3 is a block diagram of the multiple archive file merge process S201. In one embodiment, files are accessed S301 from one or more archives. These archives may be centrally located on a common network or geographically disbursed. The archives may be homogeneous or heterogeneous. The accessed files are then processed against a predetermined data structure (e.g., XML or another commercial or custom data tagging format), the results of which are stored in a common repository S303 along with the original file and its meta-data. The predetermined data structure includes means for tagging or otherwise identifying information including but not limited to file name; date last modified; date created; author; and subject.

Files that have been tagged with predetermined tags are then scanned for viruses, cleaned, tagged, and time-stamped S305. Furthermore, scanned and cleaned files are also identified as to true file type. In this context, a true file type may or may not be designated by the file type appended to the file name. For example, a .doc file may not be a word processing document as indicated by the file suffix, but may truly be another file type. A file identified with a faulty file type extension is copied with the correct file type extension, tagged, time-stamped. Files that cannot be cleaned or file type corrected are exported for further processing (not shown).

Next, files are evaluated to determine if they are encrypted and/or are password protected S307. If a file is password protected or is encrypted, it is exported for key recovery S309. Files with keys recovered are then opened and/or decrypted S311 and then re-archived, content tagged with tags per the predetermined DTD, and time-stamped S303. Files that cannot be opened are exported for further processing (not shown). Files that are neither password-protected nor encrypted are then reviewed for foreign language attributes S313. Files that are identified as to being in a non-selected language type are exported to a language conversion step S315. Files translated from their original language to a predetermined language are then content tagged with tags per the predetermined DTD, and time-stamped S303. Files that are in the desired language are stored in native format with tags and time-stamps corresponding to each of the steps of the multiple archive file merge process S201. Files that cannot be converted to a desired language are exported for further processing (not shown).

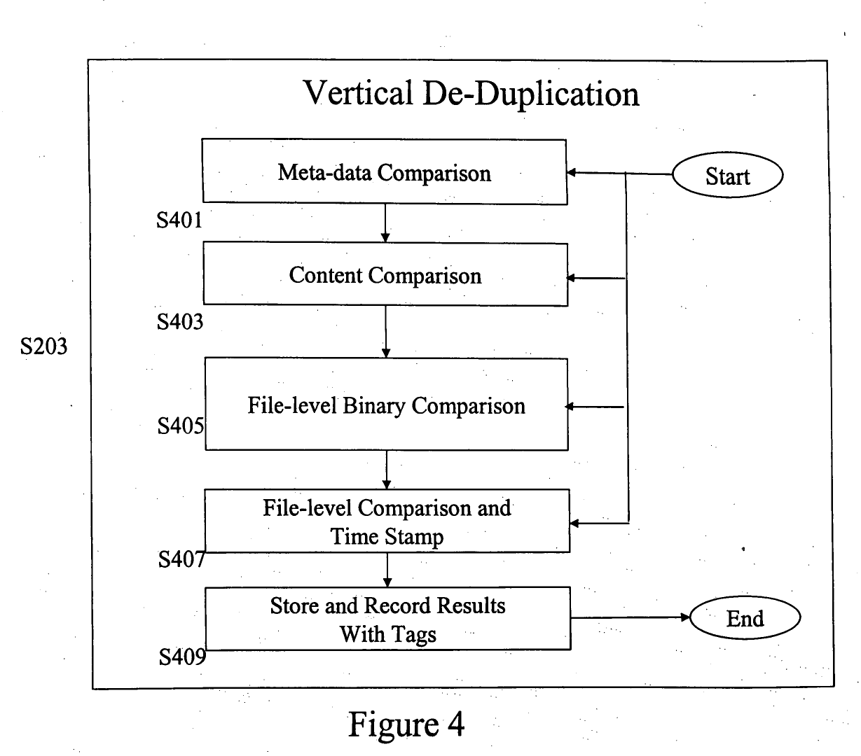

FIG. 4 is a flow chart of the vertical de-duplication process S203. Files of a single custodian are imported and compared for meta-data commonality and relationships S401. Meta-data examined includes file creation date, author name, and other non-content data. If a file is determined to be identical to a previously identified file, a flag is set for no more processing and a pointer is inserted to point to the original file. If a file is determined to be substantially related to a previously identified file, a flag is set for more processing and a pointer is inserted to point to the original file. If a file is determined to be unrelated to a previously identified file, a flag is set for more processing and no pointer is inserted to point to any other file. Meta-data comparison also includes file tagging and time-stamping.

After the meta-data comparison S401 the files are subjected to a content comparison process S403 where the printable content of the file is compared with the printable content of other files. Thus, files appended with different meta-data still may be determined to have equivalent contents. If a file is determined to be identical to a previously identified file, a flag is set for no more processing and a pointer is inserted to point to the original file. If a file is determined to be substantially related to a previously identified file, a flag is set for more processing and a pointer is inserted to point to the original file. If a file is determined to be unrelated to a previously identified file, a flag is set for more processing and no pointer is inserted to point to any other file. Content comparison also includes file tagging and time-stamping.

After content comparison S403, files are compared at a binary level S405. If a file is determined to be identical to a previously identified file, a flag is set for no more processing and a pointer is inserted to point to the original file. If a file is determined to be substantially related to a previously identified file, a flag is set for more processing and a pointer is inserted to point to the original file. If a file is determined to be unrelated to a previously identified file, a flag is set for more processing and no pointer is inserted to point to any other file. Binary comparison also includes file tagging and time-stamping.

After file binary comparison S405, files may also be subject to a combined secondary file binary comparison and time-stamp comparison S407. If a file has completed all processing and is for some reason reevaluated, the secondary file binary comparison and time-stamp comparison S407 is constructed to verify that the re-accessed file has not been altered in any fashion. Binary and time stamp comparison also includes file tagging and time-stamping.

In alternative embodiments, vertical de-duplication S203 may exclude one or more of the previous described sub-steps.

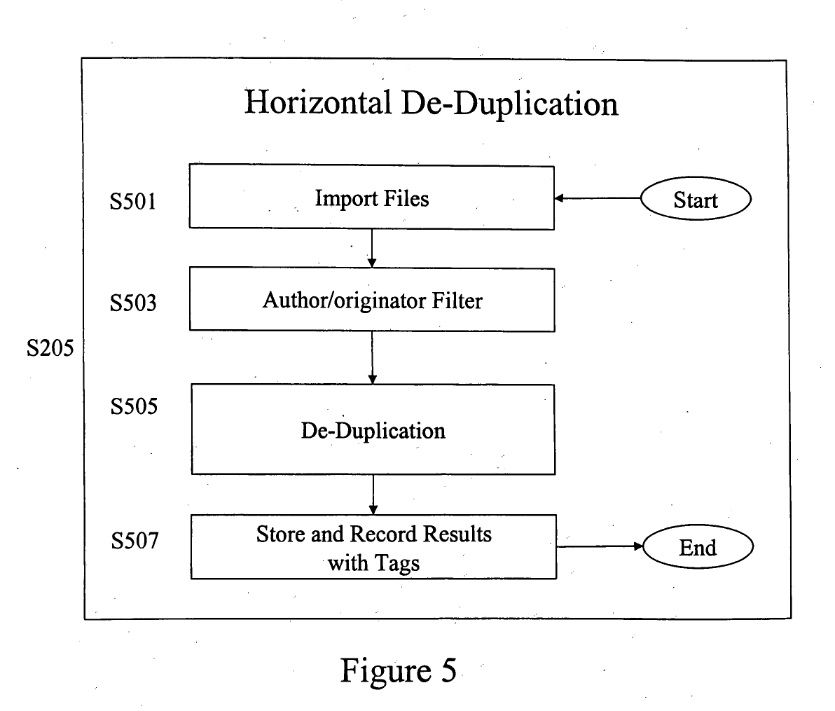

FIG. 5 is a flow chart of the horizontal de-duplication process S205. Files of multiple custodians are imported S501 and compared for common authors and/or originators S503 and then tagged and time-stamped. Files that have been identified as possible duplicates are flagged with a pointer to a possible predecessor file. Files tagged as possible duplicates are de-duplicated S505 in a manner identical to the vertical de-duplication process S203, including meta-data comparison S401, content comparison process S403, file binary comparison S405, and secondary file binary comparison and time-stamp comparison S407. Files completing the horizontal de-duplication process are time-stamped and tagged S507.

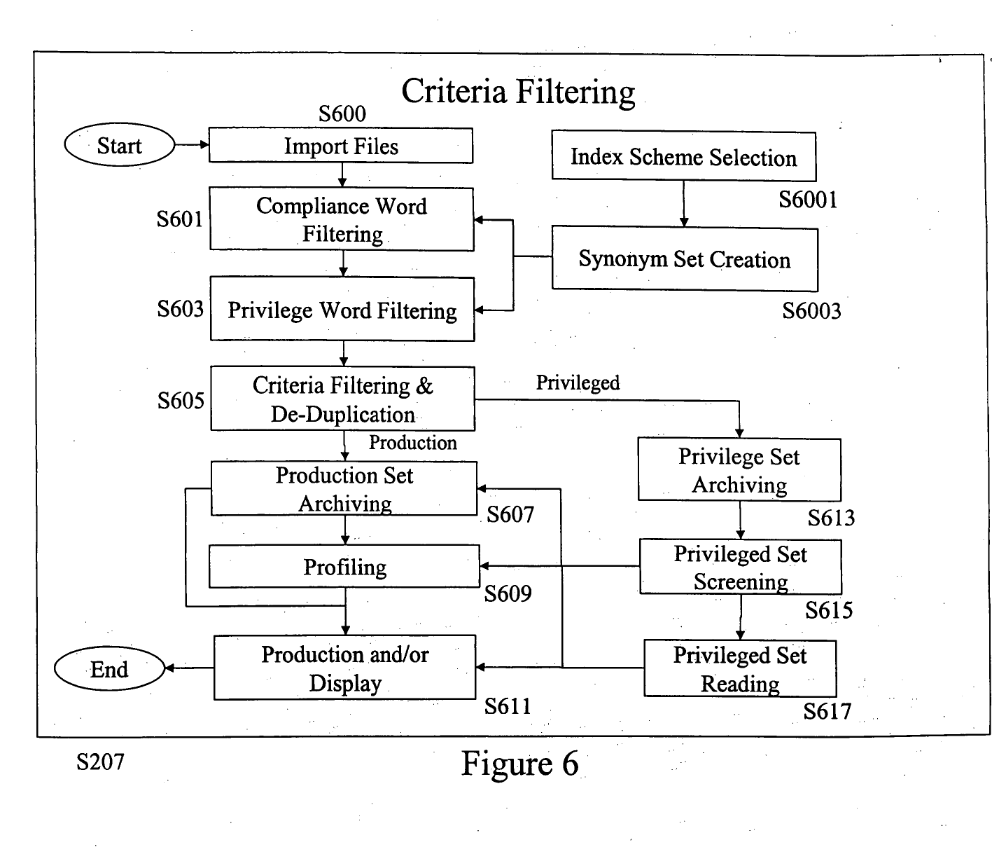

FIG. 6 is a flow chart of the criteria filtering processing process of S207. Files are imported S600 for compliance word filtering S601. Compliance words are words previously determined to be relevant to the legal discovery and/or data search underway. These compliance words may include names of people, places, dates, and/or events that are of interest to the legal discovery process. Files identified as not meeting the compliance criteria are tagged, time-stamped, and flagged for no further processing. Files flagged for no further processing may be re-examined however.

Files identified as meeting the compliance criteria are flagged for privilege word processing S603. Privileged words are words that may indicate that a file pertaining to the issue at hand should be protected from discovery by at least one side of a litigation. Files determined to be privileged are flagged for privileged treatment while files determined to be non-privileged are flagged for production.

Criteria used in both compliance word processing S601 and privilege word processing S603 are pre-determined through an index scheme selection S6001 and a synonym set creation process S6003. Index scheme selection S6001 is a process by which an operator may identify and store key terms (words, dates, etc.) corresponding to the litigation at hand. Synonyms set creation S6003 is a process by which an operator may identify and store known or suspected variants of the key terms identified by index scheme selection S6001. Each set of index and synonym criteria is time-stamped and tagged with meta-data.

Files are separated S605 for production set archiving S607 and privilege set archiving S613. Production files are those files that are determined to contain compliance words and not to contain privileged words. Privileged files are those files determined to contain compliance word and privileged words. In one embodiment, if there has been no previous vertical de-duplication S203 and/or horizontal de-duplication S205, file separation S605 also includes one or more of the substeps not previously completed. Files are also time-stamped and tagged with pointers and other reference data linking the converted file to the original file.

Production files may then be produced onto a media (paper, disk, etc.) and/or displayed S611.

Before production S611, files may be profiled S609 as described in co-pending application Ser. No. 10/227,389 so as to quantify the number of printable pages and the cost of print production.

Before production S611, files may be converted to a predetermined common format (e.g., TIFF or PDF) suitable for production or export to an existing litigation support program.

Archived privileged files may be screened S615 against a set of pre-determined screening criteria and/or read S617 to verify they are truly privileged. If determined not to privileged, these files may be included in the production set archive. Alternatively, privileged information may be excised so that non-privileged excerpts may be included in the production set archive.

Files determined to be privileged may also be produced onto a media (paper, disk, etc.) and/or displayed S611 for parties authorized to review such material.

Before production S611, privileged files also may be profiled S609 as described in co-pending application Ser. No. 10/227,389 so as to quantify the number of printable pages and the cost of print production.

Before production S611, privileged files maybe converted to a predetermined common format (e.g., TIFF or PDF) suitable for production or export to an existing litigation support program.

All accesses and handling of privileged and production sets result in tags and time-stamps being appended to the corresponding file.

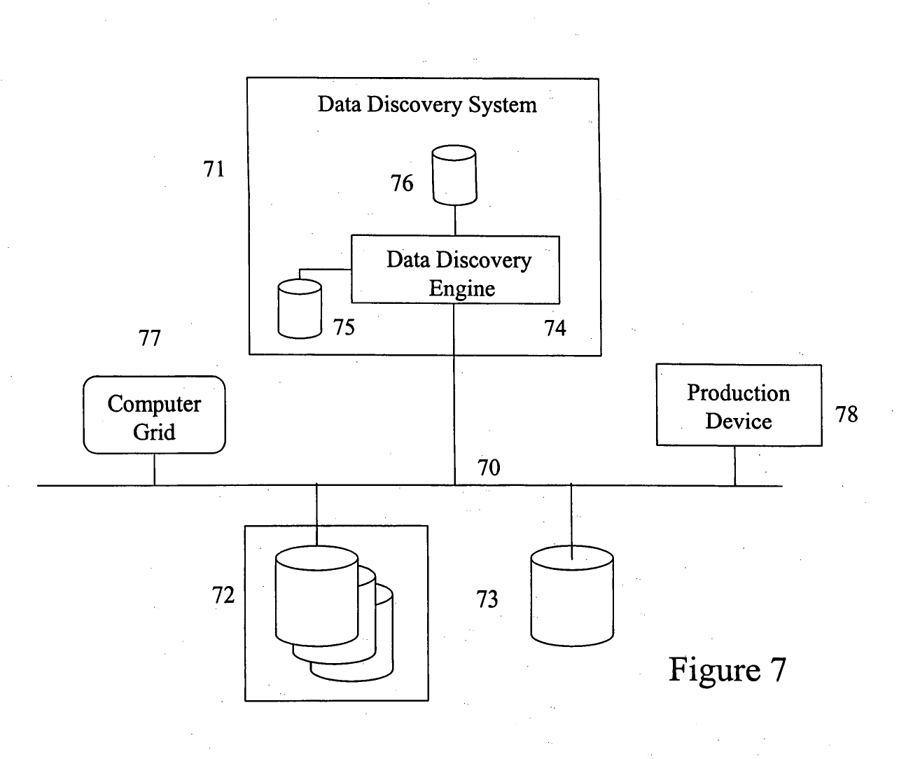

FIG. 7 is a block diagram the overarching system architecture of the present invention. The data discovery system 71 accesses one or more archives of electronically stored material 72 via an interconnection media 70. The databases 72 may be of any commercial or proprietary structure (e.g., SQL, HTML, flat files, object-oriented) and content (e.g., documents, e-mail, annotated images, annotated audio/video, etc.). The data discovery engine 74 performs a filtering and selection operation with compliance word and privilege word criteria which is either pre-stored in a criteria archive 75. The results of the data discovery process are stored in a separate data discovery repository 76. Files that require special processing may be exported to a grid computer infrastructure 77. At any time, files or statistical results of the data discovery process may be sent to a document production device 78 for printing and/or production on a media (e.g., disk, CD, etc.). Alternatively, files or statistical results of the data discovery process may be sent to one or more external storage devices.

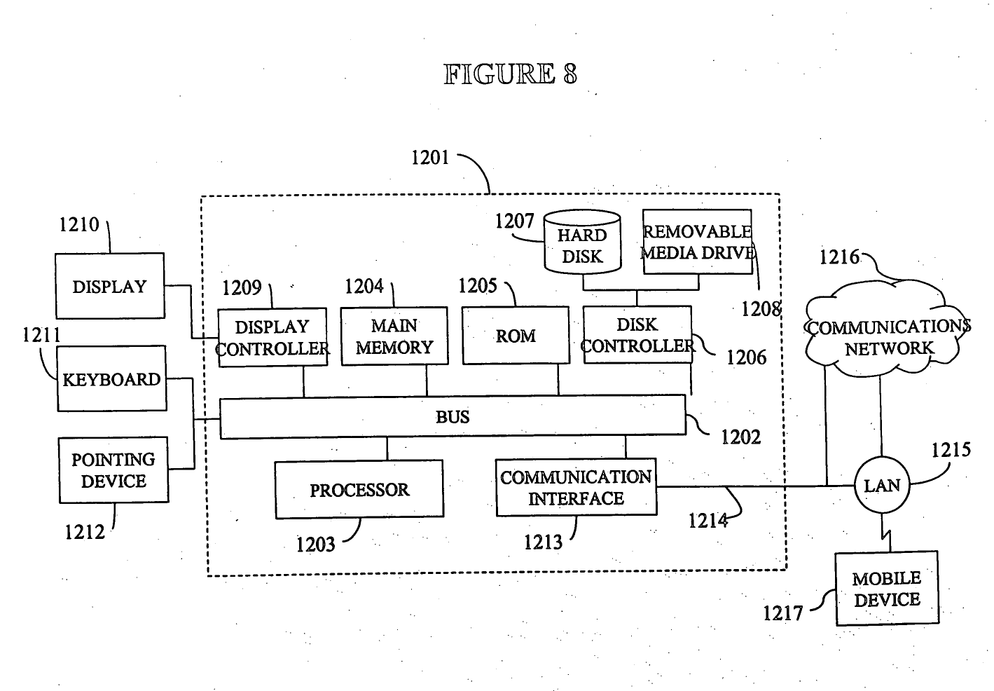

FIG. 8 is a block diagram of a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214, and the communication interface 1213. Moreover, the network link 1214 may provide a connection through a LAN 1215 to a mobile device 1217 such as a personal digital assistant (PDA) laptop computer, or cellular telephone.

The present invention includes a user-friendly interface that allows individuals of varying skill levels to search numerous digital media archives and archive types as well as allows users to design produce and print statistical reports about information stored within these archives. The interface allows users to optionally enable virus checking and duplicate checking as well as to determine and display the file types, number of files and estimate number printed pages of printable files. The interface also allows individuals to easily identify and tag duplicates, infected files, and encoded and encrypted files. The interface also allows individuals to create a time-stamp for digital authentication for each file processed. The present invention allows for such files to be sent to another device for further processing.

The present invention also includes software and computer programs designed to enable electronic legal discovery as described previously.

Obviously, numerous modifications and variations of the present invention are possible in light of the above teachings. It is therefore to be understood that within the scope of the appended claims, the invention may be practiced otherwise than as specifically described herein.

1. An electronic data discovery apparatus, comprising:
a data access and merge device configured to download a plurality of files to be filtered from at least one archive;
a de-duplication device configured to compare files from at least one custodian and tag one of said files from at least one custodian with duplication information; and
a criteria filtering device configured to screen said plurality of files against at least one of a compliance word and a privilege word.

2. The apparatus of claim 1, said data access and merge device comprising:
an predetermined data structure derived tagging module configured to tag a file with a unit of file meta-data.

3. The apparatus of claim 2, the unit of file meta-data comprising at least one of:
file name;
date last modified;
date created;
author; and
subject.

4. The apparatus of claim 1, said data access and merge device further comprising at least one of:
a virus identification and cleaning device;
an encryption/password identification and decryption/key recovery device; and
a foreign language identification and conversion device.

5. The apparatus of claim 1, said de-duplication device comprising at least one of:
a vertical de-duplication device configured to compare files from a single custodian and tag one of said files from a single custodian with vertical duplication information; and
a horizontal de-duplication device configured to compare files from a plurality of custodians and tag one of said files from a plurality of custodians with horizontal duplication information.

6. The apparatus of claim 5, said vertical de-duplication device comprising:
a meta-data comparison device;
a content comparison device;
a file binary comparison device; and
a time stamp comparison device.

7. The apparatus of claim 5, said horizontal de-duplication device comprising:
an author/originator filtering device;
a meta-data comparison device;
a content comparison device;
a file binary comparison device; and
a time stamp comparison device.

8. The apparatus of claim 1, said criteria filtering device comprising:
a compliance word filtering device configured to screen said plurality of files against a predetermined compliance word so and produce one of a compliant file and a non-compliant file;
a privileged word filtering device configured to screen said compliant file against a predetermined privileged word and produce one of a compliant, privileged file and a compliant, non-privileged file;
a production set storage device configured to store said compliant, non-privileged file; and
a privileged set storage device configured to store said compliant, privileged file.

9. The apparatus of claim 8, further comprising:
an index scheme selection device configured to store at least one of said predetermined compliance word and said predetermined privileged word; and
a synonym set creation device configured to store a synonym at least one of said predetermined compliance word and said predetermined privileged word.

10. The apparatus of claim 8, further comprising:
a file converter device configured to convert one of said compliant, non-privileged file and said compliant, privileged file to a production file; and
a profiler configured to estimate at least one of a printed page count and a cost to print said production file.

11. A system for electronic data discovery, comprising:
an electronic data discovery apparatus configured to produce at least one of a compliant, non-privileged file and a compliant, privileged file; and
a production device configured to produce a production file corresponding to said at least one of a compliant, non-privileged file and a compliant, privileged file, said electronic data discovery apparatus comprising
a data access and merge device configured to download a plurality of files to be filtered from at least one archive,
a de-duplication device configured to compare files from at least one custodian and tag one of said files from at least one custodian with duplication information, and
a criteria filtering device configured to screen said plurality of files against at least one of a compliance word and a privilege word.

12. The system of claim 11, said data access and merge device comprising:
an predetermined data structure derived tagging module configured to tag a file with a unit of file meta-data.

13. The system of claim 12, the unit of file meta-data comprising at least one of:
file name;
date last modified;
date created;
author; and
subject.

14. The system of claim 11, said data access and merge device further comprising at least one of:
a virus identification and cleaning device;
an encryption/password identification and decryption/key recovery device; and
a foreign language identification and conversion device.

15. The system of claim 11, said de-duplication device comprising at least one of:
a vertical de-duplication device configured to compare files from a single custodian and tag one of said files from a single custodian with vertical duplication information; and
a horizontal de-duplication device configured to compare files from a plurality of custodians and tag one of said files from a plurality of custodians with horizontal duplication information.

16. The system of claim 15, said vertical de-duplication device comprising:
a meta-data comparison device;
a content comparison device;
a file binary comparison device; and
a time stamp comparison device.

17. The system of claim 15, said horizontal de-duplication device comprising:
an author/originator filtering device;
a meta-data comparison device;
a content comparison device;
a file binary comparison device; and
a time stamp comparison device.

18. The system of claim 11, said criteria filtering device comprising:
a compliance word filtering device configured to screen said plurality of files against a predetermined compliance word so and produce one of a compliant file and a non-compliant file;
a privileged word filtering device configured to screen said compliant file against a predetermined privileged word and produce said one of a compliant, privileged file and a compliant, non-privileged file;
a production set storage device configured to store said compliant, non-privileged file; and
a privileged set storage device configured to store said compliant, privileged file.

19. The system of claim 11, said electronic data discovery apparatus further comprising:
a data export device configured to export at least a portion of a file to a remote processor via one of a network connection, direct connection, a wireless connection, and a portable media drive, wherein
said remote processor is configured to perform at least one of store a filter result, remove a virus, and decrypt/unprotect a file.

20. The system of claim 11, said electronic data discovery apparatus further comprising:
an external control device configured to receive instructions and provide status information to a remote control device.

21. The system of claim 11, said electronic data discovery apparatus further comprising:
a filter results storage device configured to store results of a filter operation; and
a printer connection device configured to relay information to a printer.

22. A method for performing electronic data discovery, comprising:
downloading a plurality of files to be filtered from at least one archive;
comparing files from at least one custodian and tagging one of said files from at least one custodian with duplication information; and
screening said plurality of files against at least one of a compliance word and a privilege word.

23. The method of claim 22, said downloading a plurality of files comprising:
tagging a file with a unit of file meta-data derived from an predetermined data structure.

24. The method of claim 23, the predetermined data structure comprising at least one of:
file name;
date last modified;
date created;
author; and
subject.

25. The method of claim 22, said downloading comprising at least one of:
identifying and cleaning a virus;
identifying an encrypted/password-protected file and decrypting/unprotecting said encrypted/password-protected file; and
translating a foreign language file to a predetermined language.

26. The method of claim 22, said comparing files comprising at least one of:
vertical de-duplicating files from a single custodian and tagging one of said files from a single custodian with vertical duplication information; and
horizontal de-duplicating files from a plurality of custodians tagging one of said files from a plurality of custodians with horizontal duplication information.

27. The method of claim 26, said vertical de-duplicating comprising:
comparing file meta-data;
comparing file contents
comparing file binaries; and
comparing file time stamps.

28. The method of claim 26, said horizontal de-duplicating comprising:
comparing file author/originator information;
comparing file meta-data;
comparing file contents
comparing file binaries; and
comparing file time stamps.

29. The method of claim 22, said screening comprising:
compliance word filtering said plurality of files against a predetermined compliance word and producing one of a compliant file and a non-compliant file;
privileged word filtering said compliant file against a predetermined privileged word and producing one of a compliant, privileged file and a compliant, non-privileged file;
storing said compliant, non-privileged file in a production set storage device; and
storing said compliant, privileged file in a privileged set storage device.

30. The method of claim 29, further comprising:
storing at least one of said predetermined compliance word and said predetermined privileged word in an index scheme selection device; and
storing a synonym at least one of said predetermined compliance word and said predetermined privileged word in a synonym set creation device.

31. The method of claim 29, further comprising:
converting one of said compliant, non-privileged file and said compliant, privileged file to a production file; and
estimating at least one of a printed page count and a cost to print said production file.

32. An apparatus for electronic data discovery, comprising:
means for downloading a plurality of files to be filtered from at least one archive;
means for comparing files from at least one custodian and tagging one of said files from at least one custodian with duplication information; and
means for screening said plurality of files against at least one of a compliance word and a privilege word.

33. A computer program product storing instructions for execution on a computer system, which when executed by the computer system, causes the computer system to perform the method recited in any one of claims 22-31.
